(19) United States
(12) Patent Application Publication
(10) Pub. No.: US 2025/0149576 A1
(43) Pub. Date: May 8, 2025

(54) LFP/MESHED LI-METAL BATTERY CELL

(71) Applicant: GM GLOBAL TECHNOLOGY OPERATIONS LLC, Detroit, MI (US)

(72) Inventors: Xin ZHANG, Shanghai (CN); Dewen Kong, Shanghai (CN); Meiyuan Wu, Shanghai (CN); Haijing Liu, Shanghai (CN)

(21) Appl. No.: 18/522,539

(22) Filed: Nov. 29, 2023

(30) Foreign Application Priority Data
Nov. 8, 2023 (CN) 202311484256.X

(51) Int. Cl. H01M 4/58; H01M 4/36; H01M 4/38; H01M 4/62; H01M 4/66; H01M 4/74; H01M 10/0525; H01M 10/0567; H01M 10/0568; H01M 10/0569; H01M 50/417; H01M 50/429; H01M 50/451; H01M 50/491

(52) U.S. Cl. CPC H01M 4/5825; H01M 4/366; H01M 4/382; H01M 4/623; H01M 4/662; H01M 4/74; H01M 10/0525; H01M 10/0567; H01M 10/0568; H01M 10/0569; H01M 50/417; H01M 50/4295; H01M 50/451; H01M 50/491

(57) ABSTRACT

A battery cell includes A anode electrodes including an anode active material layer comprising lithium metal active material and an anode current collector, C cathode electrodes including a cathode active material layer comprising LiFePO₄ (LFP) active material and a cathode current collector, and S separators arranged between the A anode electrodes and the C cathode electrodes, where A, C, and S are integers greater than one. The S separators comprise a substrate including a coating layer.

### CROSS-REFERENCE TO RELATED APPLICATIONS

This application claims the benefit of Chinese Patent Application No. 202311484256.X, filed on Nov. 8, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a battery cells including lithium metal anodes and LFP cathodes.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes A anode electrodes including an anode active material layer comprising lithium metal active material and an anode current collector, C cathode electrodes including a cathode active material layer comprising LiFePO₄ (LFP) active material and a cathode current collector, and S separators arranged between the A anode electrodes and the C cathode electrodes, where A, C, and S are integers greater than one. The S separators comprise a substrate including a coating layer.

In other features, the anode current collector comprises a wire mesh made of a material selected from a group consisting of copper and stainless steel. The anode current collector comprises foil made of a material selected from a group consisting of copper and stainless steel. The substrate of the S separators is selected from a polyolefin-based separator, a cellulose separator, a polyvinylidene fluoride (PVDF) membrane, and a porous polyimide membrane

In other features, the coating layer is selected from a group consisting of ceramic, polymer, alumina (Al₂O₃), Li_{1.3}Al_{0.3}Ti_{1.7}(PO₄)₃ (LATP), polyvinylidene difluoride (PVDF), polymethyl methacrylate (PMMA), and combinations thereof, and the coating layer has a thickness in a range from 1 μm to 5 μm.

In other features, the wire mesh is in a range from 50 to 400 mesh. A thickness of the A anode electrodes is in a range from 70 to 120 μm and a width of the A anode electrodes is in a range from 50 mm to 500 mm. The S separators have a thickness in a range from 9 μm to 19 μm and a porosity in a range from 35 to 55%.

In other features, the cathode active material layer comprises the LFP active material, a carbon additive, and a binder. The LFP active material comprises 90 to 98 wt %, the carbon additive comprises 1 to 5 wt %, and the binder comprises 1 to 5 wt %.

In other features, the LFP active material further includes a carbon coating. The carbon coating is in a range from 0.5 wt % to 3 wt % and the LFP is in a range from 97 wt % to 99.5 wt % of the LFP active material. The binder comprises PTFE.

In other features, the carbon additive is selected from a group consisting of Super P, KS-6, graphite, graphene nanoplates, single-walled carbon nanotubes (SWCNT), multi-walled carbon nanotubes (MWCNT), and combinations thereof. Electrolyte comprises a lithium salt, a solvent, and an additive. The lithium salt is selected from a group including LiPF₆ and LiFSI. The solvent is selected from a group consisting of carbonate ester or ether. The battery cell has an N/P ratio is in a range from 1.5 to 1.7.

A battery cell comprises A anode electrodes including an anode active material layer including lithium metal coating on an anode current collector. The anode current collector comprises a wire mesh made of a material selected from a group consisting of copper and stainless steel. C cathode electrodes include a cathode active material layer comprising a LiFePO₄ (LFP) active material with a carbon coating and a cathode current collector. S separators are arranged between the A anode electrodes and the C cathode electrodes, where A, C, and S are integers greater than one. The S separators comprise a substrate including a coating layer. The substrate is selected from a group consisting of a polyolefin-based separator, a cellulose separator, a polyvinylidene fluoride (PVDF) membrane, and a porous polyimide membrane, and combinations thereof. The coating layer is selected from a group consisting of ceramic, polymer, alumina (Al₂O₃), Li_{1.3}Al_{0.3}Ti_{1.7}(PO₄)₃(LATP), polyvinylidene difluoride (PVDF), polymethyl methacrylate (PMMA). An electrolyte comprises a lithium salt, a solvent, and an additive.

In other features, the cathode active material layer comprises the LFP active material, a carbon additive, and a binder. The LFP active material comprises 90 to 98 wt %, the carbon additive comprises 1 to 5 wt %, and the binder comprises 1 to 5 wt %. The S separators have a thickness in a range from 9 μm to 19 μm and a porosity in a range from 35 to 55%.

In other features, the carbon coating of the LFP active material is in a range from 0.5 wt % to 3 wt % and the LFP is in a range from 97 wt % to 99.5 wt %. The binder comprises PTFE. The carbon additive is selected from a group consisting of Super P, KS-6, graphite, graphene nanoplates, single-walled carbon nanotubes (SWCNT), multi-walled carbon nanotubes (MWCNT), and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including LFP cathode electrodes, lithium metal anode electrodes, and separators arranged in a battery cell enclosure according to the present disclosure;

FIGS. 2A and 2B are more detailed side cross sectional views of examples of the battery cell including LFP cathode electrodes, lithium metal anode electrodes, and separators according to the present disclosure;

FIG. 3 is a graph illustrating heat flow as a function of temperature for a graphite anode with electrolyte, a LiNi_{0.98}Co_{0.05}Mn_{0.03}Al_{0.02}O₂ (NCMA) cathode with electrolyte, a lithium iron phosphate or LiFePO₄ (LFP) cathode with electrolyte, and lithium metal anode with electrolyte according to the present disclosure;

FIG. 4 is a graph illustrating voltage as a function of capacity for the battery cell including the LFP cathode and the lithium metal anode according to the present disclosure;

FIG. 5 is a graph illustrating capacity retention as a function of cycles for the battery cell including the LFP cathode and the lithium metal anode according to the present disclosure;

FIG. 6 is a graph illustrating columbic efficiency as a function of cycles for the battery cell including the LFP cathode and the lithium metal anode according to the present disclosure; and

FIGS. 7 and 8 are graphs illustrating heat flow as a function of temperature for examples of battery cells according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Lithium ion battery cells including NMC or NMCA cathodes and graphite anodes have a high energy density and good cycling performance. However, these battery cells do not have high thermal stability and therefore thermal runaway behavior is problematic.

Battery cells according to the present disclosure include a lithium metal anode and an LFP cathode. As will be described further below, the battery cells according to the present disclosure enable high thermal stability and outstanding cyclability without sacrificing energy density.

Referring now to FIG. 1, a battery cell 10 includes C cathode electrodes 20, A anode electrodes 40, and S separators 32 arranged in a predetermined sequence in a battery stack 12 located in an enclosure 50, where C, S and A are integers greater than zero. The C cathode electrodes 20-1, 20-2, . . . , and 20-C include cathode active material layers 24 including LFP active material arranged on one or both sides of cathode current collectors 26. The A anode electrodes 40-1, 40-2, . . . , and 40-A include anode active material layers 42 including lithium metal arranged on one or both sides of the anode current collectors 46.

In some examples, the cathode current collectors 26 and the anode current collectors 46 comprise a metal mesh, metal foil, or expanded metal. In some examples, the anode current collectors 46 are made of a material selected from a group consisting of copper and stainless steel. In some examples, the cathode current collectors are made of aluminum or other suitable current collector materials.

In some examples, the cathode active material layers 24 comprise coatings including one or more active materials, one or more conductive fillers/additives, and/or one or more binder materials that are applied to the cathode current collectors 26 in a roll-to-roll production line or other manufacturing method. External tabs 28 and 48 can be connected to the current collectors of the anode electrodes and cathode electrodes on the same or opposite sides of the battery stack 12.

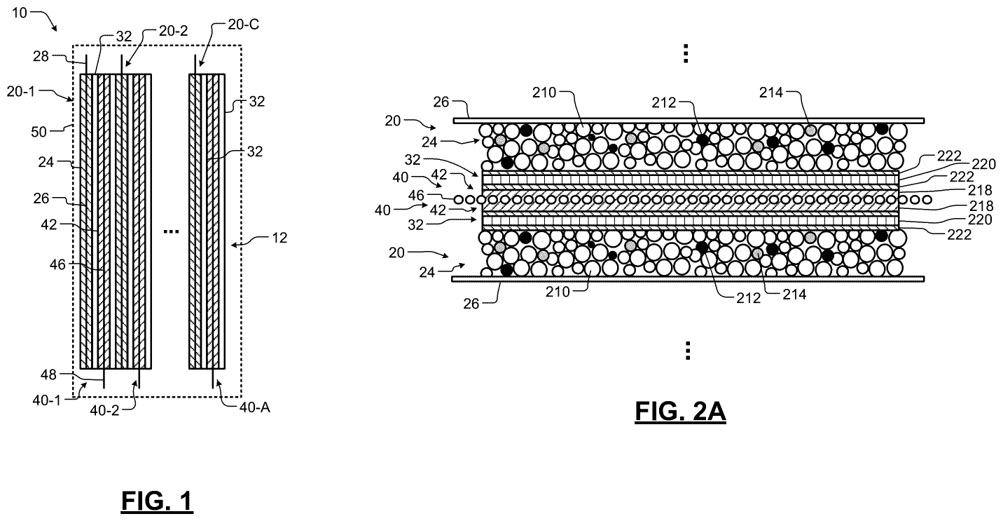

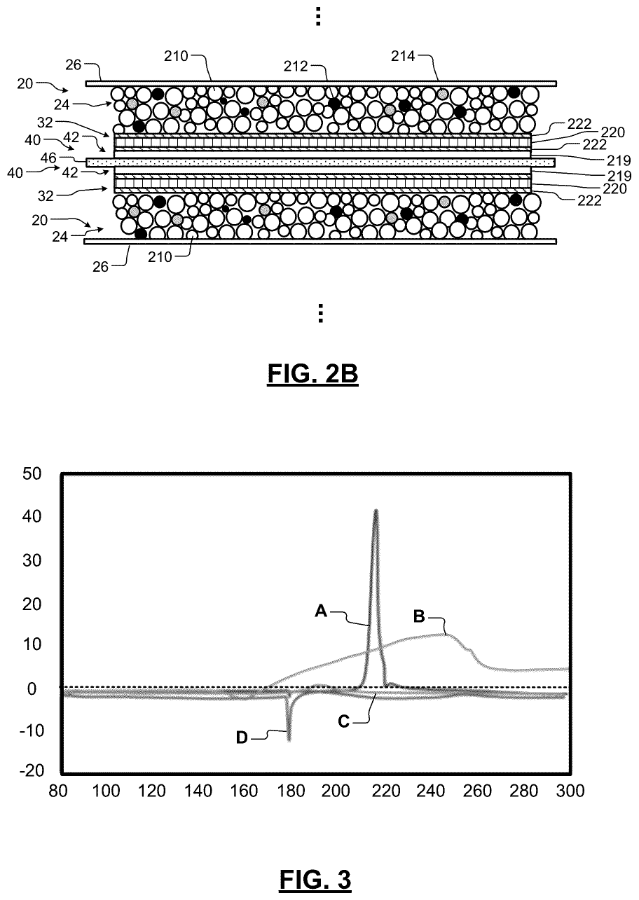

Referring now to FIGS. 2A and 2B, the cathode active material layer 24 includes LFP active material 210, a conductive additive 212, and a binder 214. The S separators 32 include a substrate 220 and a coating layer 222 arranged on opposite sides thereof. In FIG. 2A, the anode active material layer 42 includes a lithium metal coating 218 arranged on the anode current collector 46 (e.g., wire mesh).

In FIG. 2B, the anode active material layer 42 includes a lithium metal layer 219 such as lithium foil arranged on the anode current collector 46 (e.g., metal foil). In some examples, the metal foil has a thickness in a range from 5 μm to 30 μm.

In some examples, the metal mesh of the anode current collector 46 is in a range from 50 to 400 mesh (e.g., openings per inch). In some examples, the anode electrodes 40 have a capacity loading in a range from 6 to 8 mAh/cm² (e.g. 6.5 mAh/cm²) for a single-sided lithium coating having a thickness in a range from 30-40 μm. In some examples, the total thickness of the anode electrodes 40 is in a range from 70 μm to 120 μm. In some examples, the anode electrodes have a width in a range from 50 mm to 500 mm. In some examples, the anode electrodes have a width in a range from 50 mm to 200 mm.

In some examples, the substrate 220 is selected from a group consisting of a polyolefin-based separator (e.g., polyacetylene: polypropylene (PP), polyethylene (PE), dual-layer type: PP-PE, three-layer type: PP-PE-PP), a cellulose separator, a polyvinylidene fluoride (PVDF) membrane, and a porous polyimide membrane. In some examples, the coating layer 222 comprises ceramic or polymer. An example of ceramic includes alumina (Al₂O₃) or Li_{1.3}Al_{0.3}Ti_{1.7}(PO₄)₃ (LATP), although other ceramics can be used. Examples of polymer include polyvinylidene difluoride (PVDF), polymethyl methacrylate (PMMA), or another suitable polymer. The coating layer is arranged on one or both sides of the substrate 220.

In some examples, the separator 32 has a thickness in a range from 9 μm to 19 μm. In some examples, the separator 32 has a porosity in a range from 35 to 55% (e.g., 40%). In some examples, the coating layer 222 has a thickness in a range from 1 μm to 5 μm. In some examples, the separator 32 has a thickness of 16 μm, a porosity of 40%, and the coating layer 222 includes alumina (Al₂O₃) having a thickness of 2 μm.

In some examples, the cathode active material layer comprises LFP active material, a carbon additive, and a binder. In some examples, the LFP active material comprises 90 to 98 wt %, the carbon additive comprises 1 to 5 wt %, and the binder comprises 1 to 5 wt %.

In some examples, the LFP active material has a surface area of 3 m²/g to 20 m²/g. In some examples, the LFP active material further includes a carbon coating. In some examples, the carbon coating on the LFP active material is in a range from 0.5 wt % to 3 wt % and the LFP is in a range from 97 wt % to 99.5 wt %. In some examples, the LFP active material has a D₅₀ in a range from 0.5 μm to 15 μm. In some examples, the surface area of the LFP active material is 10.6 m²/g and the carbon coating comprises 1.2 wt % with a D₅₀ of 1.2 μm.

In some examples, the binder comprises PTFE. In some examples, the carbon additive is selected from a group consisting of Super P, KS-6, graphite, graphene nanoplates, single-walled carbon nanotubes (SWCNT), multi-walled carbon nanotubes (MWCNT), and combinations thereof. In some examples, the cathode active material layer comprises LFP, Super P, and PTFE at a mass ratio of 96.5:1.5:2.

In some examples, the capacity loading of the cathode electrode is in a range from 2 to 6 mAh/cm² (for single-sided coating 0.1C at room temperature). In some examples, the pressing density of the cathode electrode is in a range from 1.9 to 3.1 g/cm³ (e.g., 2.4 g/cm³). In some examples, the porosity is in a range from 25% to 45%. In some examples, the moisture content is less than 600 ppm. In some examples, the cathode electrodes have a width in a range from 50 mm to 500 mm. In some examples, the anode electrodes have a width in a range from 50 mm to 200 mm.

In some examples, the electrolyte comprises a lithium salt, a solvent, and an additive. In some examples, the lithium salt is selected from a group including LiPF₆ or LiFSI (e.g., 0.82 mol/L). In some examples, the solvent is selected from a group consisting of carbonate ester or ether. In some examples, the additives are selected from a group consisting of fluoroethylene carbonate (FEC), dimethyl carbonate (DMC), 1,1,2,2-tetrafluoroethyl-2,2,3,3-tetrafluoropropylether (TTE), and/or other additives. For example, the electrolyte may comprise 1 M LiPF₆ in FEC and DMC (1:4 volume) for a 1 Ah LFP/Li 300 Cu mesh stacking pouch battery cell. For example, the electrolyte may comprise 1 M LiPF₆ in FEC and DMC (1:4 volume) for a 1 Ah LFP/Li 100 Cu mesh stacking pouch battery cell.

In some examples, an N/P ratio is in a range from 1.5 to 1.7 (e.g., 1.66). In some examples, the battery cell has a pouch, prismatic, cylindrical, or other suitable format using stacking or winding.

Referring now to FIG. 3, heat flow is shown for a NCMA cathode with electrolyte and graphite anode with electrolyte as compared to LFP cathode with electrolyte and lithium metal anode with electrolyte. The peak intensity of the exothermic reaction in NCMA cathode at A and graphite anode at B is significantly higher than the LFP cathode at C and lithium metal anode at D, which indicates that the LFP cathode and lithium metal anode system has a much lower risk of thermal runaway than the NCMA cathode and graphite anode system.

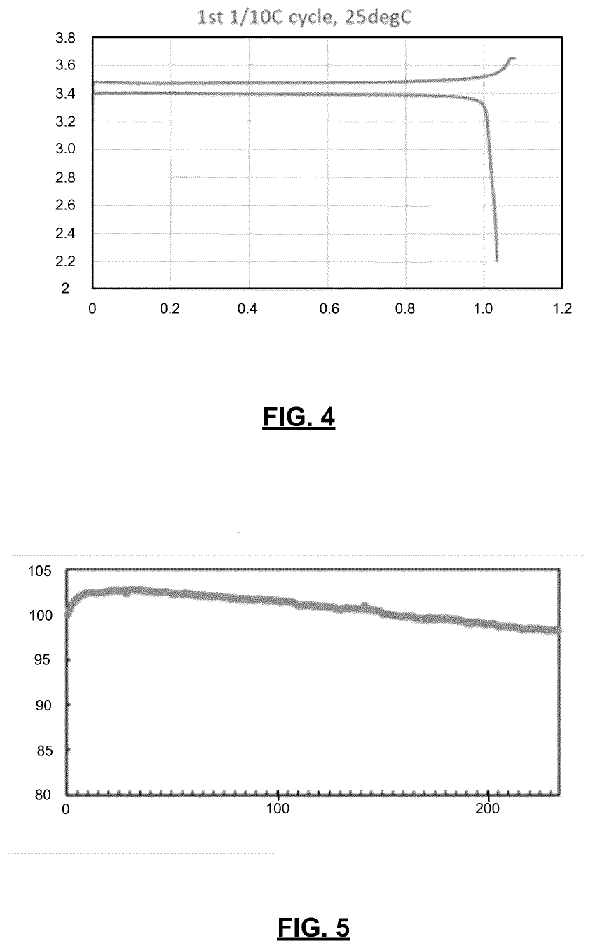

Referring now to FIG. 4, voltage is shown as a function of capacity for ˜1 Ah pouch battery cell including LFP loading of 4 mAh/cm², a press density of 2.4 g/cc, an anode including a 300 mesh Cu anode current collector with a lithium metal coating, electrolyte including 1 M LiPF₆ in FEC and DMC (1:4 volume), and an energy density of 290 Wh/kg (when calculated using a 100 Ah cell format). The initial columbic efficiency is 95.8% and the initial discharge capacity is 1.07 Ah. The voltage range is 2.2 to 3.65V, the compression pressure is 20 psi, and the CCCV charge is at C/10 and discharge at C/10.

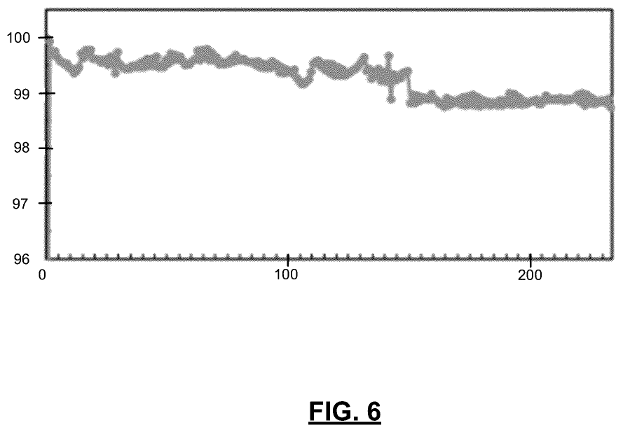

Referring now to FIGS. 5 and 6, capacity retention and columbic efficiency performance of an example battery cell comprising a 1 Ah LFP/Li 300 Cu mesh in a stacking pouch format with electrolyte including 1 M LiPF₆ in FEC and DMC (1:4 volume) is shown. The battery cell has a capacity retention of 98% and an average columbic efficiency of 99.2% after 230 cycles.

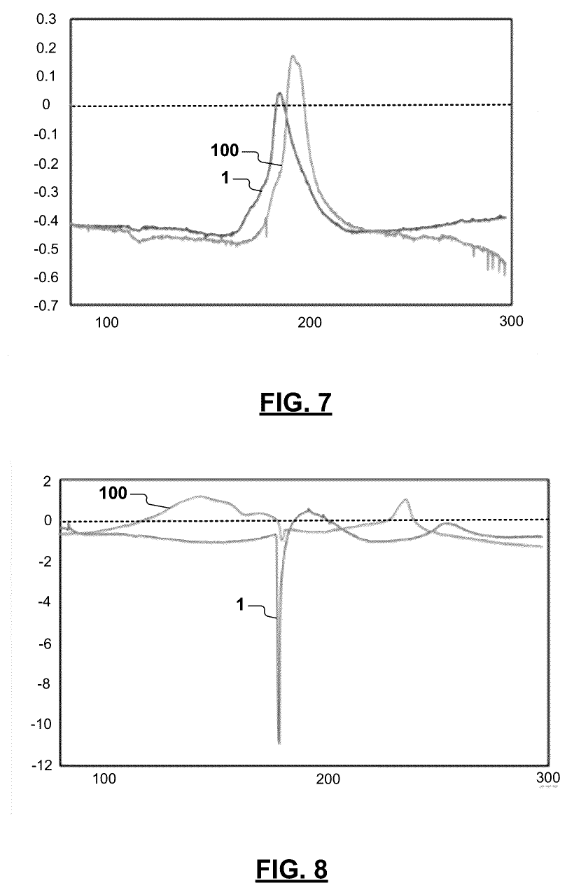

Referring now to FIGS. 7 and 8, heat flow performance of an example battery cell comprising a 1 Ah LFP/Li 300 Cu mesh stacking pouch battery cell with 1M LiPF₆ in FEC and DMC (1:4 volume) is shown. After 100 cycles, exothermic reaction of the Li anode (FIG. 7) and LFP cathode (FIG. 8) is relatively unchanged as compared with the initial performance of the Li anode and LFP cathode after 1 cycle. As can be appreciated, there is minimal heat release during thermal runaway propagation.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
A anode electrodes including an anode active material layer comprising lithium metal active material and an anode current collector;
C cathode electrodes including a cathode active material layer comprising LiFePO₄ (LFP) active material and a cathode current collector; and
S separators arranged between the A anode electrodes and the C cathode electrodes, where A, C, and S are integers greater than one,
wherein the S separators comprise a substrate including a coating layer.

2. The battery cell of claim 1, wherein the anode current collector comprises a wire mesh made of a material selected from a group consisting of copper and stainless steel.

3. The battery cell of claim 1, wherein the anode current collector comprises foil made of a material selected from a group consisting of copper and stainless steel.

4. The battery cell of claim 1, wherein the substrate of the S separators is selected from a polyolefin-based separator, a cellulose separator, a polyvinylidene fluoride (PVDF) membrane, and a porous polyimide membrane.

5. The battery cell of claim 1, wherein:
the coating layer is selected from a group consisting of ceramic, polymer, alumina (Al₂O₃), Li_{1.3}Al_{0.3}Ti_{1.7}(PO₄)₃ (LATP), polyvinylidene difluoride (PVDF), polymethyl methacrylate (PMMA), and combinations thereof, and the coating layer has a thickness in a range from 1 μm to 5 μm.

6. The battery cell of claim 2, wherein the wire mesh is in a range from 50 to 400 mesh.

7. The battery cell of claim 1, wherein a thickness of the A anode electrodes is in a range from 70 to 120 μm and a width of the A anode electrodes is in a range from 50 mm to 500 mm.

8. The battery cell of claim 1, wherein:
the S separators have a thickness in a range from 9 μm to 19 μm, and
a porosity in a range from 35 to 55%.

9. The battery cell of claim 1, wherein:
the cathode active material layer comprises the LFP active material, a carbon additive, and a binder, and
the LFP active material comprises 90 to 98 wt %, the carbon additive comprises 1 to 5 wt %, and the binder comprises 1 to 5 wt %.

10. The battery cell of claim 9, wherein:
the LFP active material further includes a carbon coating, and
the carbon coating is in a range from 0.5 wt % to 3 wt % and the LFP is in a range from 97 wt % to 99.5 wt % of the LFP active material.

11. The battery cell of claim 9, wherein the binder comprises PTFE.

12. The battery cell of claim 9, wherein the carbon additive is selected from a group consisting of Super P, KS-6, graphite, graphene nanoplates, single-walled carbon nanotubes (SWCNT), multi-walled carbon nanotubes (MWCNT), and combinations thereof.

13. The battery cell of claim 1, further comprising electrolyte comprising a lithium salt, a solvent, and an additive.

14. The battery cell of claim 13, wherein:
the lithium salt is selected from a group including LiPF₆ and LiFSI,
the solvent is selected from a group consisting of carbonate ester or ether.

15. The battery cell of claim 1, wherein the battery cell has an N/P ratio is in a range from 1.5 to 1.7.

16. A battery cell comprising:
A anode electrodes including an anode active material layer comprising lithium metal coating on an anode current collector, wherein the anode current collector comprises a wire mesh made of a material selected from a group consisting of copper and stainless steel;
C cathode electrodes including a cathode active material layer comprising a LiFePO₄ (LFP) active material with a carbon coating and a cathode current collector;
S separators arranged between the A anode electrodes and the C cathode electrodes, where A, C, and S are integers greater than one,
wherein the S separators comprise a substrate including a coating layer,
wherein the substrate is selected from a group consisting of a polyolefin-based separator, a cellulose separator, a polyvinylidene fluoride (PVDF) membrane, and a porous polyimide membrane, and combinations thereof, and
wherein the coating layer is selected from a group consisting of ceramic, polymer, alumina (Al₂O₃), Li_{1.3}Al_{0.3}Ti_{1.7}(PO₄)₃(LATP), polyvinylidene difluoride (PVDF), polymethyl methacrylate (PMMA); and
an electrolyte comprising a lithium salt, a solvent, and an additive.

17. The battery cell of claim 16, wherein:
the cathode active material layer comprises the LFP active material, a carbon additive, and a binder, and
the LFP active material comprises 90 to 98 wt %, the carbon additive comprises 1 to 5 wt %, and the binder comprises 1 to 5 wt %.

18. The battery cell of claim 16, wherein the S separators have a thickness in a range from 9 μm to 19 μm and a porosity in a range from 35 to 55%.

19. The battery cell of claim 17, wherein:
the carbon coating of the LFP active material is in a range from 0.5 wt % to 3 wt % and the LFP is in a range from 97 wt % to 99.5 wt %, and
the binder comprises PTFE.

20. The battery cell of claim 17, wherein the carbon additive is selected from a group consisting of Super P, KS-6, graphite, graphene nanoplates, single-walled carbon nanotubes (SWCNT), multi-walled carbon nanotubes (MWCNT), and combinations thereof.
